(19) United States
(12) Patent Application Publication
(10) Pub. No.: US 2024/0065224 A1
(43) Pub. Date: Feb. 29, 2024

(54) PET BED WITH COVER

(71) Applicant: Yani Lopez-Castillo, Miami Lakes, FL (US)

(72) Inventor: Yani Lopez-Castillo, Miami Lakes, FL (US)

(21) Appl. No.: 17/899,093

(22) Filed: Aug. 30, 2022

(51) Int. Cl. A01K 1/035

(52) U.S. Cl. CPC A01K 1/0353

(57) ABSTRACT

A pet bed includes a mattress configured for a domestic pet, with a cover adaptively attached to the mattress, where the cover includes a hood and a waterproof liner and the cover is adaptively attached to the mattress with a fastener. The cover may be removed from the mattress by unfastening the fastener. The fastener may be a Velcro® fastener.

### BACKGROUND

### Technical Field

This disclosure relates to pet bedding. In particular, but without limitation, this disclosure relates to a pet bed with a cover and hood.

Pet beds are known in the art.

U.S. Pat. No. 7,926,447 discloses a pet bed.

U.S. Pat. No. 8,342,126 discloses an enhanced bed system.

Pet beds do not come with hoods, requiring a blanket for pets that easily get cold. A cover with a hood solves the need to keep a pet warm without an added accessory. Additionally, the cover is lined with a waterproof, antimicrobial textile making cleaning up easier. Pet beds that do not have a removable cover tend to hold on to dirt and stains more tenaciously than others, requiring the washing of the entire bed. Offering a pet bed that allows one the ability to remove its cover increases frequency of washing and durability of the bed.

Traditionally pet beds have been sold as one piece, requiring replacement when they are dirty or washing of the entire product. Pet beds have come without hoods, requiring a blanket as well. Pet beds that do offer a removable cover are not fully lined with waterproof and antimicrobial backing.

Accordingly, there is currently a need for a pet bed with a washable cover with a hood and liner that is fastened to a mattress for easy removal and replacement.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### SUMMARY

In an aspect of the disclosure, a pet bed includes a cover for a mattress with a hood positioned on the mattress that is lined by a waterproof, antimicrobial textile, attached to an underlying, orthopedic mattress by Velcro® closures concealed on the bottom of the bed. When it is desired to separate the cover with hood from the mattress, the cover is simply pulled and stripped away from the mattress so that the cover may be washed in a washing machine and the mattress may also be manually washed or otherwise cleaned. If desired, the cover may be replaced with covers of different designs or textures.

Other systems, methods, features and advantages of the disclosure will be, or will become, apparent to one with skill in the art upon examination of the following figures and detailed description. It is intended that all such additional systems, methods, features and advantages be included within this description, be within the scope of the disclosure, and be protected by the following claims.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure. Moreover, in the figures, like referenced numerals designate corresponding parts throughout the different views.

FIG. 1a is a top view of a pet bed according to the disclosure.

FIG. 1b is a cross-section view displaying the cover and liner of the pet bed according to the disclosure.

FIG. 2 is a bottom view of a pet bed according to the disclosure.

FIG. 3 is a plan view of an aspect of a pet bed according to the disclosure.

### DETAILED DESCRIPTION

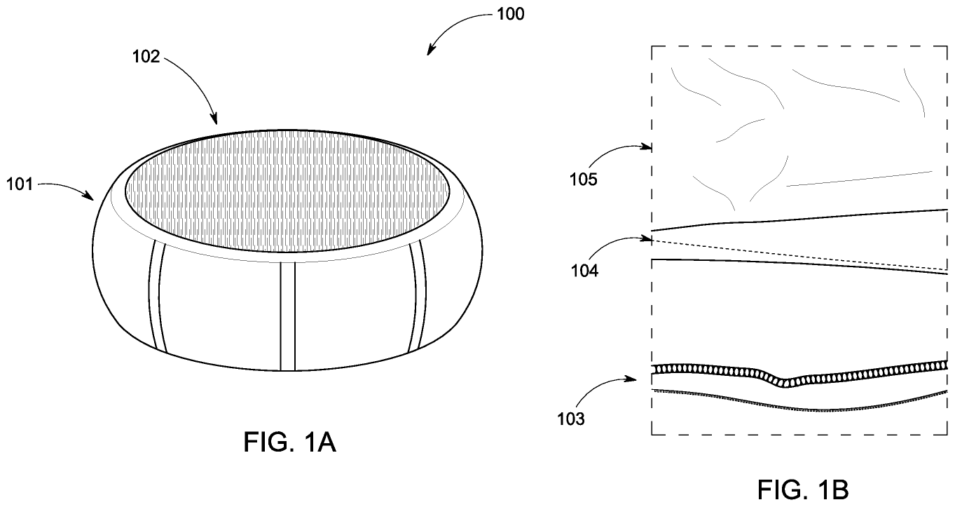

FIG. 1a is a top view of a pet bed 100 according to the disclosure. The pet bed 100 includes a mattress 101. A cover 102 is adaptively attached to the mattress 101 and covers the mattress 101 with a hood. The cover 102 may be composed of an antimicrobial textile material. The cover 102 may be adaptively attached to the mattress with adhesive fasteners, such as Velcro® fasteners. Other fasteners, such as hooks and eyelets, zippers or other fasteners known to one of skill in the art may be used. The cover 102 may be removed from the mattress 101. The cover 102 may be removed from the mattress 101 to be cleaned or replaced. The pet bed 100 may be designed to accommodate a domestic pet such as a dog, cat or other domestic pet animal. The cover 102 may be composed of fabric with similar attributes to polyester, namely, non-shrink, non-wrinkle, non-stretch, washable, and in some cases a non-toxic stain-resistant coating.

FIG. 1b a cross-section view displaying the cover and liner of the pet bed according to the disclosure. A non-lined surface of a cover 103 is a part of the cover 102. A waterproof liner 104 is adhered to the cover 102. A ground surface 104 lies below the waterproof liner 104.

When it is desired to separate the cover 102 with hood from the mattress 101, the cover 102 is simply pulled and stripped away from the mattress 101 so that the cover 102 may be washed in a washing machine and the mattress 101 may also be manually washed or otherwise cleaned. If desired, the cover 102 may be replaced with covers of different designs or textures

In an aspect of the disclosure, the mattress 101 may be an orthopedic mattress designed for pets. The mattress 101 may be designed in different sizes and shapes. The cover 102 may be designed to fit the various shapes and sizes of the mattress 101. In one aspect of the disclosure, the mattress 101 may include a cross-section that is circular or donut-shaped. In this aspect, the cover 102 may be designed accordingly to fit the mattress 101. In another aspect, the mattress 101 may be square or rectangular-shaped. The cover 102 may then be accordingly designed to fit over the mattress 101 in this instance. In one aspect of the disclosure, the mattress 101 may be rectangular with dimensions of 27″ wide by 36″ long by 4″ height. The cover 102 with hood may be accordingly sized and shaped to fit the mattress 101.

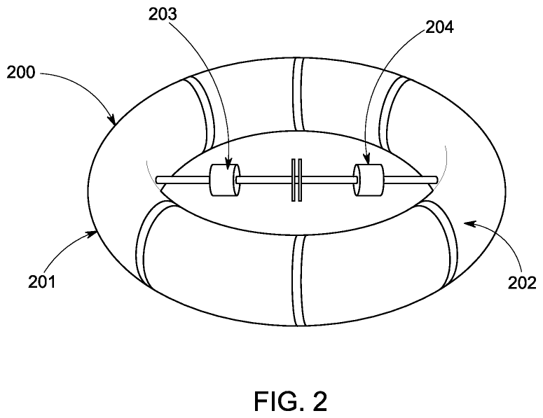

FIG. 2 is a bottom view of a pet bed 200 according to the disclosure. The pet bed 200 includes a mattress 201. A cover 202 with hood is adaptively attached to the mattress 201 and covers the mattress 201 with a hood. The cover 202 may be composed of a waterproof and/or antimicrobial textile material. The cover 202 may be adaptively attached to the mattress with adhesive fasteners, such as Velcro fasteners (203, 204). One or more Velcro fasteners may be used to secure the cover 202 to the mattress 201. Other fasteners, such as hooks and loops, zippers or other fasteners known to one of skill in the art may be used. The cover 202 may be removed from the mattress 201 by unfastening the Velcro® fasteners (203, 204). The cover 202 may be removed from the mattress 201 to be cleaned or replaced.

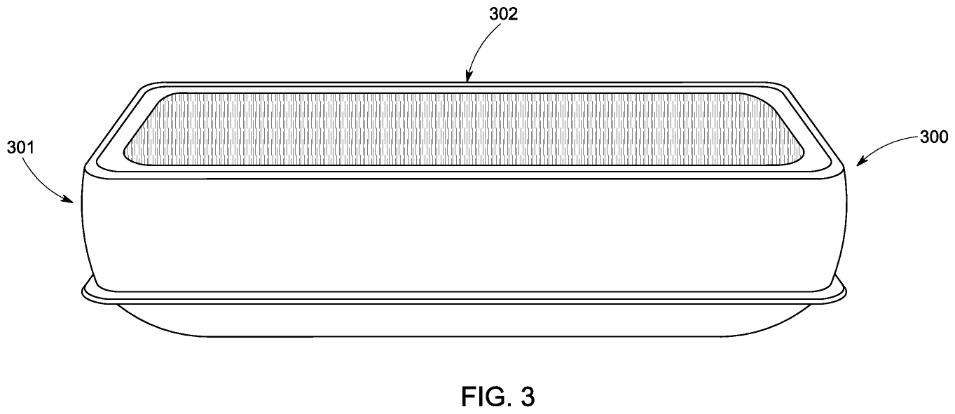

FIG. 3 is a plan view of an aspect of a pet bed 300 according to the disclosure. The pet bed 300 includes a mattress 301. A cover 302 is adaptively attached to the mattress 301 and covers the mattress 301 with a hood. The cover 302 may be composed of a waterproof and/or antimicrobial textile material. The cover 302 may be adaptively attached to the mattress with adhesive fasteners, such as Velcro® fasteners. Other fasteners, such as hooks and loops, zippers or other fasteners known to one of skill in the art may be used. The cover 302 may be removed from the mattress 301. The cover 302 may be removed from the mattress 301 to be cleaned or replaced.

In an aspect of the disclosure, the mattress 301 may be an orthopedic mattress designed for pets. The mattress 301 may be designed in different sizes and shapes. The cover 302 may be designed to fit the various shapes and sizes of the mattress 301. In one aspect of the disclosure, the mattress 301 may include a cross-section with a rectangular-shape with dimensions of 27″ wide by 36″ long by 4″ height. The cover 302 with hood may be accordingly sized and shaped to fit the mattress 301. The mattress 301 may also be composed of memory foam, shredded memory foam, polyester fiber (dura-soft), and down feathers. Sizes also available are 22″×27″×5″ (small), 20″×20″×5″ (square) and 20″ and 36″ Dx5 (round small and round large).

While various aspects of the disclosure have been described, it will be apparent to those of ordinary skill in the art that many more aspects and implementations are possible within the scope of the disclosure. Accordingly, the disclosure is not to be restricted except in light of the attached claims and their equivalents.

What is claimed is:

1. A pet bed comprising:
a mattress configured for a domestic pet;
a cover adaptively attached to the mattress, where the cover comprises a hood and a waterproof liner and the cover is adaptively attached to the mattress with a fastener, where the cover may be removed from the mattress by unfastening the fastener.

2. The pet bed of claim 1, where the fastener comprises a Velcro® fastener.

3. The pet bed of claim 1, where the mattress comprises an orthopedic mattress.

4. The pet bed of claim 1, where the cover comprises a waterproof textile material.

5. The pet bed of claim 1, where the cover comprises an antimicrobial textile material.

6. The pet bed of claim 1, where the mattress comprises a cross-section with a donut-shape.

7. The pet bed of claim 1, where the mattress comprises a cross-section with a rectangular-shape.
